(19) United States
(12) Patent Application Publication
(10) Pub. No.: US 2024/0340950 A1
(43) Pub. Date: Oct. 10, 2024

(54) METHOD AND DEVICE FOR BIDIRECTIONAL COMMUNICATION IN WIRELESS LAN

(71) Applicant: ELECTRONICS AND TELECOMMUNICATIONS RESEARCH INSTITUTE, Daejeon (KR)

(72) Inventors: Sung Hyun HWANG, Daejeon (KR); Kyu Min KANG, Daejeon (KR); Jae Cheol PARK, Daejeon (KR); Jin Hyung OH, Daejeon (KR); Dong Woo LIM, Daejeon (KR); Su Na CHOI, Daejeon (KR); Yong Ho KIM, Incheon (KR)

(21) Appl. No.: 18/291,550

(22) PCT Filed: Aug. 11, 2022
(86) PCT No.: PCT/KR2022/011994

§ 371 Date: Jan. 23, 2024

(30) Foreign Application Priority Data
Aug. 17, 2021 (KR) 10-2021-0108231

(51) Int. Cl. H04W 74/0816

(52) U.S. Cl. CPC H04W 74/0816

(57) ABSTRACT

Disclosed are a method and device for bidirectional communication in a wireless LAN. The method of a first STA comprises the steps of: receiving, from an AP, a first frame including an information element indicating TXOP sharing; confirming a shared TXOP duration on the basis of the first frame; and communicating with a second STA within the shared TXOP duration.

### TECHNICAL FIELD

The present disclosure relates to a wireless local area network (LAN) communication technique, and more particularly, to a technique for bidirectional communication within a transmit opportunity (TXOP).

### BACKGROUND ART

Recently, as the spread of mobile devices expands, a wireless local area network technology capable of providing fast wireless communication services to mobile devices is in the spotlight. The wireless LAN technology may be a technology that supports mobile devices such as smart phones, smart pads, laptop computers, portable multimedia players, embedded devices, and the like to wirelessly access the Internet based on wireless communication technology.

The standards using the wireless LAN technology are being standardized as IEEE802.11 standards mainly in the Institute of Electrical and Electronics Engineers (IEEE). As the above-described wireless LAN technologies have been developed and spread, applications using the wireless LAN technologies have been diversified, and a demand for a wireless LAN technology supporting a higher throughput has arisen. Accordingly, a frequency bandwidth (e.g., ‘maximum 160 MHz bandwidth’ or ‘80+80 MHz bandwidth’) used in the IEEE 802.11ac standard has been expanded, and the number of supported spatial streams has also increased. The IEEE 802.11ac standard may be a very high throughput (VHT) wireless LAN technology supporting a high throughput of 1 gigabit per second (Gbps) or more. The IEEE 802.11ac standard can support downlink transmission for multiple stations by utilizing the MIMO techniques.

As applications requiring higher throughput and applications requiring real-time transmission occur, the IEEE 802.11be standard, which is an extreme high throughput (EHT) wireless LAN technology, is being developed. The goal of the IEEE 802.11be standard may be to support a high throughput of 30 Gbps. The IEEE 802.11be standard may support techniques for reducing a transmission latency. In addition, the IEEE 802.11be standard can support a more expanded frequency bandwidth (e.g., 320 MHz bandwidth), multi-link transmission and aggregation operations including multi-band operations, multiple access point (AP) transmission operations, and/or efficient retransmission operations (e.g., hybrid automatic repeat request (HARQ) operations).

However, since EHT communication operations are operations not defined in the existing wireless LAN standard, it may be necessary to define detailed operations according to an environment in which the EHT communication operations are performed. In particular, frame transmission may be performed based on the EHT communication operations within a transmit opportunity (TXOP) duration secured through contention, but the frame transmission operation within the TXOP duration may be performed in only one direction. Therefore, methods for performing bidirectional communication within the TXOP duration may be required.

Meanwhile, the technologies that are the background of the present disclosure are written to improve the understanding of the background of the present disclosure and may include content that is not already known to those of ordinary skill in the art to which the present disclosure belongs.

### DISCLOSURE

### Technical Problem

The present disclosure is directed to providing a method and an apparatus for bidirectional communication in a wireless LAN system.

### Technical Solution

A method of a first station (STA), according to a first exemplary embodiment of the present disclosure for achieving the above-described objective, may comprise: receiving, from an access point (AP), a first frame including an information element indicating transmit opportunity (TXOP) sharing; identifying a shared TXOP duration based on the first frame; and performing communication with a second STA within the shared TXOP duration.

The method may further comprise transmitting a second frame which is a response to the first frame, wherein the first frame is a multi-user-request-to-send (MU-RTS) frame, and the second frame is a clear-to-send (CTS) frame.

A TXOP sharing mode may be classified into a TXOP sharing mode 1 or a TXOP sharing mode 2; the first frame may further include an information element indicating the TXOP sharing mode 2; when the TXOP sharing mode 1 is indicated, communication between the first STA and the AP may be allowed within the shared TXOP duration; and when the TXOP sharing mode 2 is indicated, direct communication between the first STA and the second STA may be allowed within the shared TXOP duration.

The first frame may further include an information element indicating a length of the shared TXOP duration, and the shared TXOP duration may be configured within a TXOP duration initiated by the AP.

The first frame may further include an information element indicating whether reverse direction communication is allowed within the shared TXOP duration.

The first frame may further include an information element indicating an access category (AC) of a data unit transmittable in a link to which the TXOP sharing is applied.

The performing of the communication with the second STA may comprise: transmitting, to the second STA and within the shared TXOP duration, at least one of a data unit corresponding to an AC equal to the AC indicated by the first frame or a data unit corresponding to an AC having a higher priority than the AC indicated by the first frame.

The first frame may include an association identifier (AID) of each of a plurality of STAs performing communications within the shared TXOP duration, a first AID included in the first frame may be an AID of the first STA that is a target of the TXOP sharing, and a second AID included in the first frame may be an AID of the second STA.

The performing of the communication with the second STA may comprise: transmitting a first data frame to the second STA; receiving a reception response frame to the first data frame from the second STA; and receiving a second data frame from the second STA, wherein the first data frame includes at least one of an information element indicating whether reverse direction communication is allowed within the shared TXOP duration or an information element indicating an AC of a data unit for which the reverse direction communication is allowed.

A method of an access point (AP), according to a second exemplary embodiment of the present disclosure for achieving the above-described objective, may comprise: securing a transmit opportunity (TXOP) duration; generating a first frame including an information element indicating TXOP sharing, an information element indicating a length of a shared TXOP duration within the TXOP duration, an information element indicating that direct communication between a plurality of STAs is allowed within the shared TXOP duration, and an association identifier (AID) of each of the plurality of STAs performing the direct communication within the shared TXOP duration; transmitting the first frame to a first STA among the plurality of STAs; and receiving a second frame that is a response to the first frame from the first STA.

The TXOP duration may be secured by transmitting a clear-to-send (CTS)-to-self frame, the first frame may be a multi-user-request-to-send (MU-RTS) frame, and the second frame may be a CTS frame.

The first frame may further include at least one of an information element indicating whether reverse direction communication is allowed within the shared TXOP duration or an information element indicating an access category (AC) of a data unit transmittable in a link to which the TXOP sharing is applied.

A first STA, according to a third exemplary embodiment of the present disclosure for achieving the above-described objective, may comprise: a processor; a memory electronically communicating with the processor; and instructions stored in the memory, wherein when executed by the processor, the instructions cause the first STA to: receive, from an access point (AP), a first frame including an information element indicating transmit opportunity (TXOP) sharing; identify a shared TXOP duration based on the first frame; and perform communication with a second STA within the shared TXOP duration.

A TXOP sharing mode may be classified into a TXOP sharing mode 1 or a TXOP sharing mode 2; the first frame may further include an information element indicating the TXOP sharing mode 2; when the TXOP sharing mode 1 is indicated, communication between the first STA and the AP may be allowed within the shared TXOP duration; and when the TXOP sharing mode 2 is indicated, direct communication between the first STA and the second STA may be allowed within the shared TXOP duration.

The first frame may further include an information element indicating a length of the shared TXOP duration, and the shared TXOP duration may be configured within a TXOP duration initiated by the AP.

The first frame may further include an information element indicating whether reverse direction communication is allowed within the shared TXOP duration.

The first frame may further include an information element indicating an access category (AC) of a data unit transmittable in a link to which the TXOP sharing is applied.

In the performing of the communication with the second STA, the instructions may further cause the first STA to transmit, to the second STA and within the shared TXOP duration, at least one of a data unit corresponding to an AC equal to the AC indicated by the first frame or a data unit corresponding to an AC having a higher priority than the AC indicated by the first frame.

The first frame may include an association identifier (AID) of each of a plurality of STAs performing communications within the shared TXOP duration, a first AID included in the first frame may be an AID of the first STA that is a target of the TXOP sharing, and a second AID included in the first frame may be an AID of the second STA.

In the performing of the communication with the second STA, the instructions may further cause the first STA to: transmit a first data frame to the second STA; receive a reception response frame to the first data frame from the second STA; and receive a second data frame from the second STA, wherein the first data frame includes at least one of an information element indicating whether reverse direction communication is allowed within the shared TXOP duration or an information element indicating an AC of a data unit for which the reverse direction communication is allowed.

### Advantageous Effects

According to the present disclosure, a first communication node may secure a TXOP duration by performing a channel contention procedure, and may perform communication (e.g., forward direction communication) with a second communication node within the TXOP duration. The first communication node may share a TXOP duration with the second communication node. In this case, the second communication node may perform communication (e.g., reverse direction communication) with the first communication node within a shared TXOP duration. That is, bidirectional communication (e.g., forward direction communication and reverse direction communication) may be performed within the TXOP duration. According to the above-described operations, since a channel contention time for the reverse direction communication can be reduced, a low-latency requirements can be satisfied. In addition, by reducing a latency, high-speed communication can be performed.

### DESCRIPTION OF DRAWINGS

FIG. 1 is a conceptual diagram illustrating a first exemplary embodiment of a wireless LAN system.

FIG. 2 is a block diagram illustrating a first exemplary embodiment of a communication node constituting a wireless LAN system.

FIG. 3 is a conceptual diagram illustrating a first exemplary embodiment of a multi-link configured between multi-link devices (MLDs).

FIG. 4 is a sequence chart illustrating an association procedure of a station in a wireless LAN system.

FIG. 5 is a timing diagram illustrating a first exemplary embodiment of an operation method of a communication node based on EDCA.

FIG. 6 is a timing diagram illustrating a first exemplary embodiment of a bidirectional communication method in a wireless LAN system.

FIG. 7 is a timing diagram illustrating a second exemplary embodiment of a bidirectional communication method in a wireless LAN system.

FIG. 8 is a timing diagram illustrating a third exemplary embodiment of a bidirectional communication method in a wireless LAN system.

FIG. 9 is a timing diagram illustrating a fourth exemplary embodiment of a bidirectional communication method in a wireless LAN system.

FIG. 10 is a timing diagram illustrating a fifth exemplary embodiment of a bidirectional communication method in a wireless LAN system.

FIG. 11 is a timing diagram illustrating a sixth exemplary embodiment of a bidirectional communication method in a wireless LAN system.

FIG. 12 is a timing diagram illustrating a seventh exemplary embodiment of a bidirectional communication method in a wireless LAN system.

FIG. 13 is a timing diagram illustrating an eighth exemplary embodiment of a bidirectional communication method in a wireless LAN system.

FIG. 14 is a timing diagram illustrating a ninth exemplary embodiment of a bidirectional communication method in a wireless LAN system.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

In the following, a wireless communication system to which exemplary embodiments according to the present disclosure are applied will be described. The wireless communication system to which the exemplary embodiments according to the present disclosure are applied is not limited to the contents described below, and the exemplary embodiments according to the present disclosure can be applied to various wireless communication systems. A wireless communication system may be referred to as a ‘wireless communication network’.

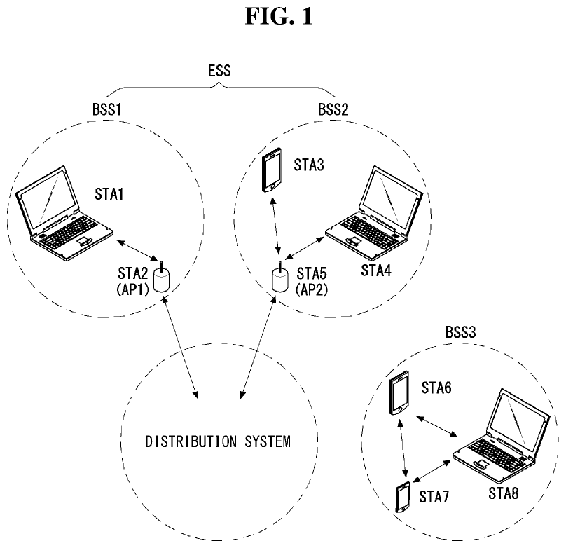

FIG. 1 is a conceptual diagram illustrating a first exemplary embodiment of a wireless LAN system.

Referring to FIG. 1, a wireless LAN system may include at least one basic service set (BSS). A BSS may refer to a set of stations (e.g., STA1, STA2 (AP1), STA3, STA4, STA5 (AP2), STA6, STA7, and STA8) that can communicate with each other through successful synchronization, and may not refer to a specific region. In exemplary embodiments below, a station performing functions as an access point may be referred to as an ‘access point (AP)’, and a station not performing functions as an access point may be referred to as a ‘non-AP station’ or a ‘station’.

The BSS may be classified into an infrastructure BSS and an independent BSS (IBSS). Here, a BSS1 and a BSS2 may mean infrastructure BSSs, and a BSS3 may mean an IBSS. The BSS1 may include a first station (STA1), a first access point (STA2 (AP1)) providing a distribution service, and a distribution system (DS) connecting a plurality of access points (STA2 (AP1) and STA5 (AP2)). In the BSS1, the first access point STA2 (AP1) may manage the first station STA1.

The BSS2 may include a third station (STA3), a fourth station (STA4), a second access point (STA5 (AP2)) providing a distribution service, and a DS connecting the plurality of access points (STA2 (AP1) and STA5 (AP2)). In the BSS2, the second access point STA5 (AP2) may manage the third station STA3 and the fourth station STA4.

The BSS3 may mean an IBSS operating in an ad-hoc mode. An access point, which is a centralized management entity, may not exist in the BSS3. That is, in the BSS3, the stations STA6, STA7, and STA8 may be managed in a distributed manner. In the BSS3, all stations STA6, STA7, and STA8 may refer to mobile stations, and since they are not allowed to access a DS, they may constitute a self-contained network.

The access points STA2 (APT) and STA5 (AP2) may provide access to the DS for the stations STA1, STA3, and STA4 associated therewith via a wireless medium. In the BSS1 or BSS2, communications between the stations STA1, STA3, and STA4 are generally performed through the access points STA2 (APT) and STA5 (AP2), but when direct links are established, direct communications between the stations STA1, STA3, and STA4 may be possible.

A plurality of infrastructure BSSs may be interconnected through a DS. The plurality of BSSs connected through the DS may be referred to as an extended service set (ESS). The communication nodes STA1, STA2 (APT), STA3, STA4, and STA5 (AP2) included in the ESS may communicate with each other, and an arbitrary station (STA1, STA3, or STA4) may move from one BSS to another BSS within the same ESS while communicating without interruption.

The DS may be a mechanism for one access point to communicate with another access point, according to which an access point may transmit frames for stations associated with the BSS it manages, or transmit frames for an arbitrary station that has moved to another BSS. Also, the access point may transmit and receive frames to and from an external network such as a wired network. Such the DS may not necessarily have to be a network, and if it can provide a predetermined distribution service stipulated in the IEEE 802.11 standard, there is no restriction on its form. For example, the DS may be a wireless network such as a mesh network or a physical structure that connects the access points to each other. The communication nodes STA1, STA2 (AP1), STA3, STA4, STA5 (AP2), STA6, STA7, and STA8 included in the wireless LAN system may be configured as follows.

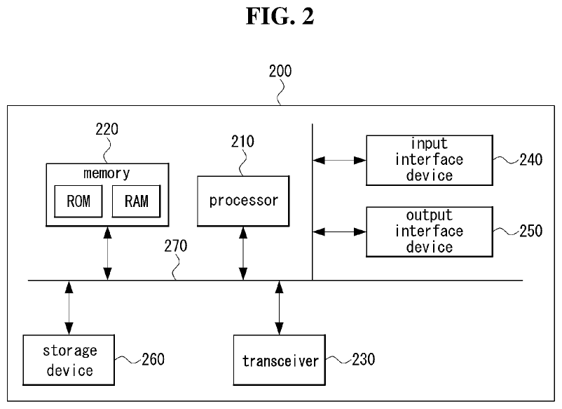

FIG. 2 is a block diagram illustrating a first exemplary embodiment of a communication node constituting a wireless LAN system.

Referring to FIG. 2, a communication node 200 may include at least one processor 210, a memory 220, and a transceiver 230 connected to a network to perform communications. The transceiver 230 may be referred to as a transceiver, a radio frequency (RF) unit, an RF module, or the like. In addition, the communication node 200 may further include an input interface device 240, an output interface device 250, a storage device 260, and the like. The respective components included in the communication node 200 may be connected by a bus 270 to communicate with each other.

However, the respective components included in the communication node 200 may be connected through individual interfaces or individual buses centering on the processor 210 instead of the common bus 270. For example, the processor 210 may be connected to at least one of the memory 220, the transceiver 230, the input interface device 240, the output interface device 250, and the storage device 260 through a dedicated interface.

The processor 210 may execute program commands stored in at least one of the memory 220 and the storage device 260. The processor 210 may refer to a central processing unit (CPU), a graphics processing unit (GPU), or a dedicated processor on which the methods according to the exemplary embodiments of the present invention are performed. Each of the memory 220 and the storage device 260 may be configured as at least one of a volatile storage medium and a nonvolatile storage medium. For example, the memory 220 may be configured with at least one of a read only memory (ROM) and a random access memory (RAM).

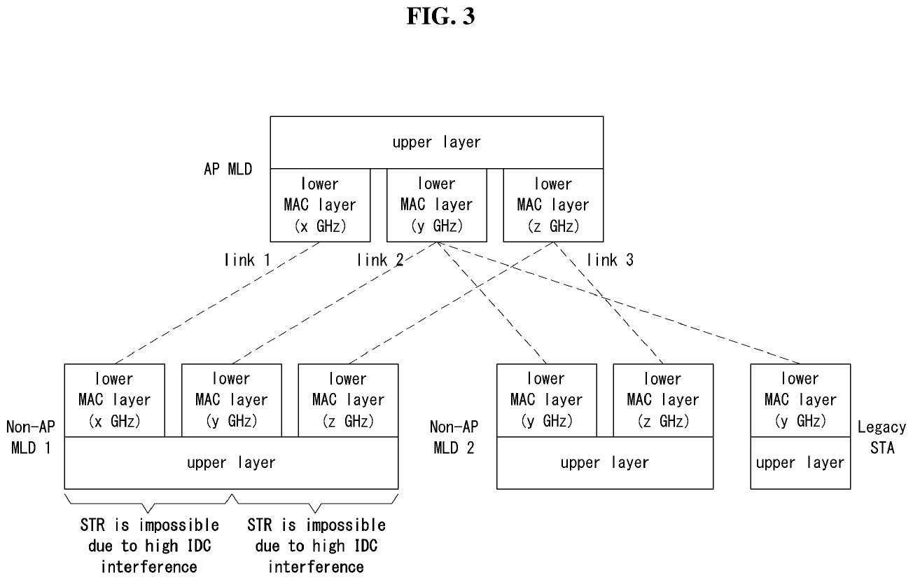

FIG. 3 is a conceptual diagram illustrating a first exemplary embodiment of a multi-link configured between multi-link devices (MLDs).

Referring to FIG. 3, an MLD may have one medium access control (MAC) address. In exemplary embodiments, the MLD may mean an AP MLD and/or non-AP MLD. The MAC address of the MLD may be used in a multi-link setup procedure between the non-AP MLD and the AP MLD. The MAC address of the AP MLD may be different from the MAC address of the non-AP MLD. AP(s) affiliated with the AP MLD may have different MAC addresses, and station(s) affiliated with the non-AP MLD may have different MAC addresses. Each of the APs having different MAC addresses within the AP MLD may be in charge of each link, and may perform a role of an independent AP.

Each of the STAs having different MAC addresses within the non-AP MLD may be in charge of each link, and may perform a role of an independent STA. The non-AP MLD may be referred to as a STA MLD. The MLD may support a simultaneous transmit and receive (STR) operation. In this case, the MLD may perform a transmission operation in a link 1 and may perform a reception operation in a link 2. The MLD supporting the STR operation may be referred to as an STR MLD (e.g., STR AP MLD, STR non-AP MLD). In exemplary embodiments, a link may mean a channel or a band. A device that does not support the STR operation may be referred to as a non-STR (NSTR) AP MLD or an NSTR non-AP MLD (or NSTR STA MLD).

The MLD may transmit and receive frames in multiple links by using a non-contiguous bandwidth extension scheme (e.g., 80 MHz+80 MHz). The multi-link operation may include multi-band transmission. The AP MLD may include a plurality of APs, and the plurality of APs may operate in different links. Each of the plurality of APs may perform function(s) of a lower MAC layer. Each of the plurality of APs may be referred to as a ‘communication node’ or ‘lower entity’. The communication node (i.e., AP) may operate under control of an upper layer (or the processor 210 shown in FIG. 2). The non-AP MLD may include a plurality of STAs, and the plurality of STAs may operate in different links. Each of the plurality of STAs may be referred to as a ‘communication node’ or ‘lower entity’. The communication node (i.e., STA) may operate under control of an upper layer (or the processor 210 shown in FIG. 2).

The MLD may perform communications in multiple bands (i.e., multi-band). For example, the MLD may perform communications using an 80 MHz bandwidth according to a channel expansion scheme (e.g., bandwidth expansion scheme) in a 2.4 GHz band, and perform communications using a 160 MHz bandwidth according to a channel expansion scheme in a 5 GHz band. The MLD may perform communications using a 160 MHz bandwidth in the 5 GHz band, and may perform communications using a 160 MHz bandwidth in a 6 GHz band. One frequency band (e.g., one channel) used by the MLD may be defined as one link. Alternatively, a plurality of links may be configured in one frequency band used by the MLD. For example, the MLD may configure one link in the 2.4 GHz band and two links in the 6 GHz band. The respective links may be referred to as a first link, a second link, and a third link. Alternatively, each link may be referred to as a link 1, a link 2, a link 3, or the like. A link number may be set by an access point, and an identifier (ID) may be assigned to each link.

The MLD (e.g., AP MLD and/or non-AP MLD) may configure a multi-link by performing an access procedure and/or a negotiation procedure for a multi-link operation. In this case, the number of links and/or link(s) to be used in the multi-link may be configured. The non-AP MLD (e.g., STA) may identify information on band(s) capable of communicating with the AP MLD. In the negotiation procedure for a multi-link operation between the non-AP MLD and the AP MLD, the non-AP MLD may configure one or more links among links supported by the AP MLD to be used for the multi-link operation. A station that does not support a multi-link operation (e.g., IEEE 802.11a/b/g/n/ac/ax STA) may be connected to one or more links of the multi-link supported by the AP MLD.

Each of the AP MLD and the STA MLD may have an MLD MAC address, and each of the AP and the STA operating in each link may have a MAC address. The MLD MAC address of the AP MLD may be referred to as an AP MLD MAC address, and the MLD MAC address of the STA MLD may be referred to as a STA MLD MAC address. The MAC address of the AP may be referred to as an AP MAC address, and the MAC address of the STA may be referred to as a STA MAC address. In a multi-link negotiation procedure, the AP MLD MAC address and the STA MLD MAC address may be used. The address of the AP and the address of the STA may be exchanged and/or configured in the multi-link negotiation procedure.

When the multi-link negotiation procedure is completed, the AP MLD may generate an address table and manage and/or update the address table. One AP MLD MAC address may be mapped to one or more AP MAC addresses, and corresponding mapping information may be included in the address table. One STA MLD MAC address may be mapped to one or more STA MAC addresses, and corresponding mapping information may be included in the address table. The AP MLD may identify address information based on the address table. For example, when a STA MLD MAC address is received, the AP MLD may identify one or more STA MAC addresses mapped to the STA MLD MAC address based on the address table.

In addition, the STA MLD may manage and/or update the address table. The address table may include ‘mapping information between the AP MLD MAC address and the AP MAC address(es)’ and/or ‘mapping information between the STA MLD MAC address and the STA MAC address(es)’. The AP MLD may receive a packet from a network, identify an address of a STA MLD included in the packet, identify link(s) supported by the STA MLD, and may identify STA(s) taking charge of the link(s) from the address table. The AP MLD may set STA MAC address(es) of the identified STA(s) as a receiver address(es), and may generate and transmit frame(s) including the receiver address(es).

Meanwhile, an association procedure in a wireless LAN system may be performed as follows.

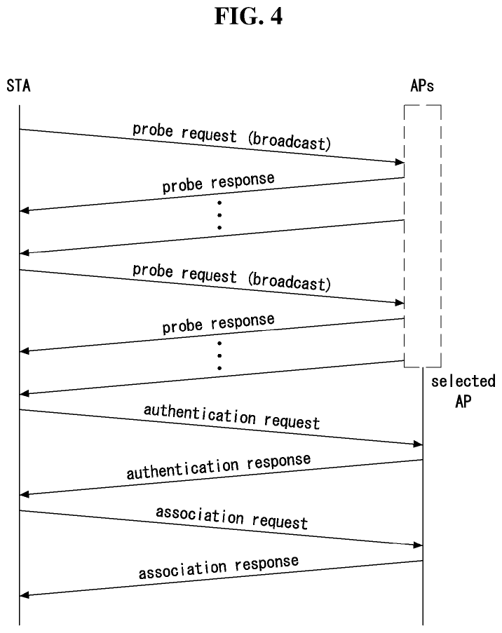

FIG. 4 is a sequence chart illustrating an association procedure of a station in a wireless LAN system.

Referring to FIG. 4, an association procedure of a STA in an infrastructure BSS may generally be divided into a probe step of detecting AP(s), an authentication step with detected AP(s), and an association step with the authenticated AP(s). The STA may be a STA MLD or a STA affiliated with the STA MLD, and the AP may be an AP MLD or an AP affiliated with the AP MLD.

The STA may detect neighboring APs using a passive scanning scheme or an active scanning scheme. When the passive scanning scheme is used, the STA may detect neighboring APs by overhearing beacons transmitted by APs. When the active scanning scheme is used, the STA may transmit a probe request frame, and may detect neighboring APs by receiving probe response frames that are responses to the probe request frame from the APs.

When the neighboring APs are detected, the STA may perform an authentication step with the detected AP(s). In this case, the STA may perform the authentication step with a plurality of APs. An authentication algorithm according to the IEEE 802.11 standard may be classified into an open system algorithm of exchanging two authentication frames, a shared key algorithm of exchanging four authentication frames, and the like.

The STA may transmit an authentication request frame based on the authentication algorithm according to the IEEE 802.11 standard, and may complete authentication with the AP by receiving an authentication response frame that is a response to the authentication request frame from the AP.

When the authentication with the AP is completed, the STA may perform an association step with the AP. In this case, the STA may select one AP among AP(s) with which the STA has performed the authentication step, and perform the association step with the selected AP. That is, the STA may transmit an association request frame to the selected AP, and may complete the association with the selected AP by receiving an association response frame that is a response to the association request frame from the selected AP.

Meanwhile, communication nodes (e.g., access points, stations, and the like) belonging to the wireless LAN system may perform transmission and reception operations of frames based on a point coordination function (PCF), hybrid coordination function (HCF), HCF controlled channel access (HCCA), distributed coordination function (DCF), enhanced distributed channel access (EDCA), and/or the like.

In the wireless LAN system, frames may be classified into a management frame, a control frame, and a data frame. The management frame may include an association request frame, association response frame, reassociation request frame, reassociation response frame, probe request frame, probe response frame, beacon frame, disassociation frame, authentication frame, deauthentication frame, action frame, and the like.

The control frame may include an acknowledgment (ACK) frame, block ACK request (BAR) frame, block ACK (BA) frame, power saving (PS)-Poll frame, request-to-send (RTS) frame, clear-to-send (CTS) frame, and the like. The data frame may be classified into a quality of service (QoS) data frame and a non-QoS data frame. The QoS data frame may refer to a data frame for which transmission according to a QoS is required, and the non-QoS data frame may indicate a data frame for which transmission according to a QoS is not required.

Meanwhile, in a wireless LAN system, a communication node (e.g., access point or station) may operate based on the EDCA scheme.

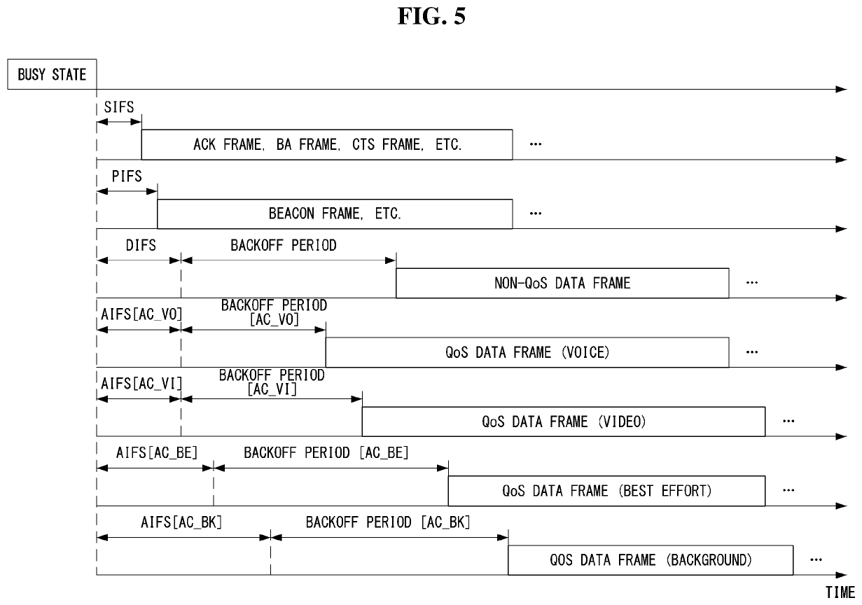

FIG. 5 is a timing diagram illustrating a first exemplary embodiment of an operation method of a communication node based on EDCA.

Referring to FIG. 5, a communication node desiring to transmit a control frame (or a management frame) may perform a channel state monitoring operation (e.g., carrier sensing operation) during a predetermined period (e.g., short interframe space (SIFS) or PCF IFS (PIFS)), and when the channel state is determined to be idle during the predetermined period (e.g., SIFS or PIFS), the communication node may transmit the control frame (or the management frame). For example, the communication node may transmit an ACK frame, a BA frame, a CTS frame, or the like when the channel state is determined to be idle during SIFS. Also, the communication node may transmit a beacon frame or the like when the channel state is determined to be idle during the PIFS. On the other hand, when it is determined that the channel state is busy during the predetermined period (e.g., SIFS or PIFS), the communication node may not transmit the control frame (or the management frame). Here, the carrier sensing operation may refer to a clear channel assessment (CCA) operation.

A communication node desiring to transmit a non-QoS data frame may perform a channel state monitoring operation (e.g., carrier sensing operation) during DCF IFS (DIFS), and when the channel state is determined to be idle during the DIFS, the communication node may perform a random backoff procedure. For example, the communication node may select a backoff value (e.g., a backoff counter) within a contention window according to the random backoff procedure and may perform a channel state monitoring operation (e.g., carrier sensing operation) during a period corresponding to the selected backoff value (hereinafter, referred to as ‘backoff period’). The communication node may transmit the non-QoS data frame when the channel state is determined to be idle in the backoff period.

A communication node desiring to transmit a QoS data frame may perform a channel state monitoring operation (e.g., carrier sensing operation) during an arbitration IFS (AIFS), and when the channel state is determined to be idle during the AIFS, the communication node may perform a random backoff procedure. The AIFS may be configured according to an access category (AC) of a data unit (e.g., protocol data unit (PDU)) included in the QoS data frame. The AC of the data unit may be as shown in Table 1 below.

TABLE 1

| Priority | AC | Description |
|---|---|---|
| Lowest | AC_BK | Background |
| | AC_BE | Best effort |
| | AC_VI | Video |
| Highest | AC_VO | Voice |

AC_BK may indicate background data, AC_BE may indicate data transmitted in the best effort manner, AC_VI may indicate video data, AC_VO may indicate voice data. For example, the length of the AIFS for the QoS data frame corresponding to each of AC_VO and AC_VI may be configured to be equal to the length of the DIFS. The length of the AIFS for the QoS data frame corresponding to each of AC_BE and AC_BK may be configured to be longer than the length of the DIFS. Here, the length of the AIFS for the QoS data frame corresponding to AC_BK may be configured to be longer than the length of the AIFS for the QoS data frame corresponding to AC_BE.

In the random backoff procedure, the communication node may select a backoff value (e.g., a backoff counter) within a contention window according to the AC of the QoS data frame. The contention window according to the AC may be as shown in Table 2 below. CWₘᵢₙ may indicate a minimum value of the contention window, CWₘₐₓ may indicate a maximum value of the contention window, and each of the minimum value and the maximum value of the contention window may be represented by the number of slots.

TABLE 2

| AC | CWₘᵢₙ | CWₘₐₓ |
|---|---|---|
| AC_BK | 31 | 1023 |
| AC_BE | 31 | 1023 |
| AC_VI | 15 | 31 |
| AC_VO | 7 | 15 |

The communication node may perform a channel state monitoring operation (e.g., carrier sensing operation) in the backoff period and may transmit the QoS data frame when the channel state is determined to be idle in the backoff period.

Hereinafter, data transmission and reception methods in a wireless LAN system will be described. Even when a method (e.g., transmission or reception of a signal) performed at a first communication node among communication nodes is described, a corresponding second communication node may perform a method (e.g., reception or transmission of the signal) corresponding to the method performed at the first communication node. That is, when an operation of a terminal is described, the corresponding base station may perform an operation corresponding to the operation of the terminal. Conversely, when an operation of the base station is described, the corresponding terminal may perform an operation corresponding to the operation of the base station.

Hereinafter, a wireless communication network to which exemplary embodiments according to the present disclosure are applied will be described. The wireless communication network to which exemplary embodiments according to the present disclosure are applied is not limited to the content described below, and exemplary embodiments according to the present disclosure may be applied to various wireless communication networks.

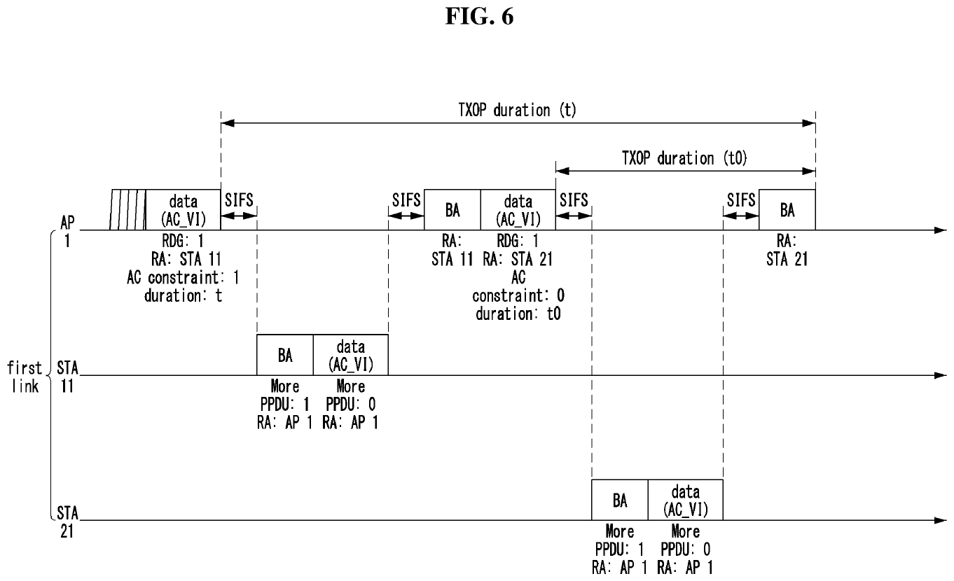

FIG. 6 is a timing diagram illustrating a first exemplary embodiment of a bidirectional communication method in a wireless LAN system.

Referring to FIG. 6, an AP MLD, a STA MLD 1, and a STA MLD 2 may support multi-link operations. An AP 1 among APs affiliated with the AP MLD may operate in a first link, a STA 11 among STAs affiliated with the STA MLD 1 may operate in the first link, and a STA 21 among STAs affiliated with the STA MLD 2 may operate in the first link. The AP may be referred to as an AP STA, and the STA may be referred to as a non-AP STA.

The AP 1 may transmit a frame to STA(s) by performing a channel contention procedure (e.g., channel access procedure) in one link (e.g., first link) of a multi-link. A communication procedure between the AP 1 and the STA(s) may be initiated by performing the channel contention procedure. The AP 1 may perform the communication procedure during a transmit opportunity (TXOP) duration configured within a TXOP limit defined for each AC. A value of a duration field included in a header (e.g., MAC header) of the frame (e.g., data frame) transmitted by the AP 1 may be set to the TXOP duration (e.g., t).

The header of the frame (e.g., data frame) transmitted by the AP 1 may include at least one of a reverse direction grant (RDG) field, an AC constraint field, or an AC information field. The AC information field may indicate an AC of a data unit included in the data frame transmitted by the AP 1. In exemplary embodiments, a data unit may mean a MAC protocol data unit (MPDU), an MPDU frame, a physical layer protocol data unit (PPDU), a PPDU frame, and/or a data frame. Transmission of a data unit may refer to transmission of a data frame including the data unit.

An ‘RDG/more PPDU’ field may be interpreted as an RDG indicator or a more PPDU indicator. In exemplary embodiments, the RDG field may mean the RDG/more PPDU field interpreted as an RDG indicator, and a more PPDU field may mean the RDG/more PPDU field interpreted as a more PPDU indicator. The RDG field may indicate whether reverse direction communication is allowed within the TXOP duration. For example, the RDG field may indicate whether the STA (e.g., STA 11 or STA 21) receiving the data unit is allowed to transmit a frame to the AP within the TXOP duration (e.g., t). The RDG field set to a first value (e.g., 0) may indicate that reverse direction communication is not allowed. The RDG field set to a second value (e.g., 1) may indicate that reverse direction communication is allowed.

The forward direction communication and the reverse direction communication may be determined based on the AP. In this case, in the forward direction communication, a frame may be transmitted from the AP to the STA, and in the reverse direction communication, a frame may be transmitted from the STA to the AP. Alternatively, the forward direction communication and the reverse direction communication may be determined based on a TXOP owner or a TXOP holder. In this case, in the forward direction communication, a frame may be transmitted from the TXOP owner or TXOP holder to a communication node (e.g., AP or STA), and in the reverse direction communication, a frame may be transmitted from a communication node (e.g., AP or STA) to the TXOP owner or TXOP holder.

An AC constraint indicator (e.g., AC constraint field) may be used to indicate an AC of a data unit for which reverse direction communication is allowed. The AC constraint indicator set to a first value (e.g., 0) may indicate that transmission of a data unit corresponding to an AC different from the AC of the data unit of the frame including the RDG field is allowed. The AC constraint indicator set to a second value (e.g., 1) may indicate that transmission of a data unit corresponding to the same AC as the AC of the data unit of the frame including the RDG field is allowed.

The size of each of the RDG field and the AC constraint field may be 1 bit. An A-control field (e.g., CAS A-control field) including a control ID subfield indicating a command and status (CAS) may include the RDG field and/or the AC constraint field. That is, the CAS A-control field may be used for transmission of the RDG field and/or the AC constraint field. The RDG/more PPDU field may be interpreted as the more PPDU field. The more PPDU field set to a first value (e.g., 0) may indicate that a data unit to be additionally transmitted does not exist. The more PPDU field set to a second value (e.g., 1) may indicate that a data unit to be additionally transmitted exists.

The STA (e.g., STA 11 or STA 21) may perform reverse direction communication based on the RDG field. When a data unit to be additionally transmitted other than the currently transmitted data unit exists in the STA, the STA may transmit, to the AP, a frame including a more PPDU field set to the second value (e.g., more PPDU field indicating that a data unit to be additionally transmitted exists). The more PPDU field set to the second value may be used to request a more PPDU (e.g., additional data unit). An RDG/more PPDU field included in the last data frame transmitted by the STA (e.g., STA 11 or STA 21) for which reverse direction communication is allowed may be interpreted as a more PPDU field, and the more PPDU field set to the first value may indicate that a data unit to be additionally transmitted does not exist in the STA.

In the exemplary embodiment of FIG. 6, the AP 1 may secure a TXOP duration in the first link and may transmit a data frame to the STA 11. The data frame may include an RDG field set to the second value (e.g., 1), a receiver address (RA) field indicating the STA 11, and an AC constraint field set to the second value (e.g., 1). The RDG field set to the second value may allow reverse direction communication to the STA 11 indicated by the RA field. ‘Allowing the reverse direction communication by the AP 1 to the STA 11 within the TXOP duration’ may mean ‘the AP 1 shares a specific period within the TXOP duration with the STA 11’. That is, the operation of allowing reverse direction communication may be interpreted as a TXOP sharing operation. The AC constraint field set to the second value may allow transmission (e.g., reverse direction communication) of a data unit corresponding to the same AC as the AC of the current data frame including the corresponding AC constraint field.

In a multi-link communication, traffic transmitted and received in a link may be determined based on a traffic identifier (TID)-to-link mapping, and a mapping relationship between TID and AC may be established. An AC of a data unit transmitted in the link may be determined based on the TID-to-link mapping and the TID-to-AC mapping. In exemplary embodiments, a communication node (e.g., AP) that initiates reverse direction communication may be referred to as a reverse direction (RD) initiator, and a communication node (e.g. STA) for which reverse direction communication is indicated to be allowed may be referred to as an RD responder. When the RD responder is an MLD (e.g., STA MLD), the AC constraint field may indicate whether to allow transmission of a data unit corresponding to an AC equal to the AC mapped to the link and/or an AC having a higher priority than the AC mapped to the link.

AC_VO may have the highest priority, AC_VI may have a lower priority than AC_VO, AC_BE may have a lower priority than AC_VI, and AC_BK may have a lower priority than AC_BE. Alternatively, when the RD responder is an MLD (e.g., STA MLD), the AC constraint indicator may indicate whether to allow transmission of a data unit corresponding to an AC having a TXOP limit shorter than a TXOP limit of the AC mapped to the link. The TXOP limit for each AC may be set as shown in Table 3 below. Alternatively, the TXOP limit may be set separately.

TABLE 3

| AC | TXOP limit |
|---|---|
| AC_BK | 2.528 ms |
| AC_BE | 2.528 ms |
| AC_VI | 4.096 ms |
| AC_VO | 2.080 ms |

Meanwhile, the STA 11 may receive the data frame from the AP 1 and may identify the information element(s) included in the data frame. When the RDG field included in the data frame is set to the second value (e.g., 1), the STA 11 may determine that the AP 1 has allowed reverse direction communication (e.g., TXOP sharing) to the STA 11. In this case, the AP 1 may be an RD initiator initiating reverse direction communication, and the STA 11 may be an RD responder for which reverse direction communication is indicated to be allowed. The STA 11 may transmit a reception response frame to the data frame to the AP 1. The reception response frame may be an immediate response to the data frame. In exemplary embodiments, the reception response frame may be an acknowledgment (ACK) frame or a block ACK (BA) frame.

When a data unit to be transmitted exists in the STA 11 based on the reverse direction communication scheme, the STA 11 may generate a header including a more PPDU field (e.g., MorePPDU field) set to the second value (e.g., 1), and may transmit the reception response frame including the corresponding header to the AP 1. A specific bit (e.g., 1 bit) within the frame may be used as an RDG field or the more PPDU field. That is, the specific bit may indicate an ‘RDG/more PPDU field’. Interpretation of the RDG/more PPDU field may vary depending on a type (e.g., RD initiator or RD responder) of the communication node. The RDG/more PPDU field included in the frame transmitted by the RD initiator may be interpreted as the RDG field (i.e., RDG indicator). The RDG/more PPDU field included in the frame transmitted by the RD responder may be interpreted as the more PPDU field (i.e., more PPDU indicator). For example, the RDG/more PPDU field included in the reception response frame (e.g., BA frame) transmitted by the STA (e.g., STA 11 or STA 21) that is the RD responder may be interpreted as the more PPDU field.

The RDG/more PPDU field included in the reception response frame transmitted by the STA 11 may be interpreted as the more PPDU field, and the more PPDU field may be set to the second value (e.g., 1). In this case, the STA 11 may generate an aggregated (A)-MPDU by concatenating the reception response frame and the data unit (e.g., data frame), and may transmit the A-MPDU to the AP 1. Alternatively, the STA 11 may transmit the reception response frame, and may transmit the data frame (e.g., PPDU) after a reduced inter-frame space (RIFS) or short inter-frame space (SIFS) from a transmission time of the reception response frame. In this case, the A-MPDU may not be generated. The STA 11 may select one AC (e.g., AC_VI) from among AC(s) mapped to the first link, and may transmit the data unit having the selected AC. When a data unit to be additionally transmitted does not exist in the STA 11, the field of the more PPDU included in the data frame may be set to the first value (e.g., 0).

The AP 1 may receive the data frame from the STA 11 and may transmit a reception response frame (e.g., BA frame) to the data frame to the STA 11. In this case, the AP 1 may transmit the data unit to the STA(s) in the remaining TXOP duration. The reception response frame transmitted by the RD initiator may not include a CAS A-control field. That is, the reception response frame transmitted by the RD initiator may not include an RDG/more PPDU

### FIELD

The AP 1 may identify whether a data unit to be additionally transmitted to the STA 11 exists by checking a memory (e.g., buffer). Also, the AP 1 may identify whether there is a data unit to be additionally transmitted by the STA 11 to the AP 1 based on the more PPDU field included in the previous data frame received from the STA 11. According to whether or not each communication node (e.g., AP or STA) has a data unit to be additionally transmitted, cases defined in Table 4 below may be considered.

TABLE 4

| | Data unit to be transmitted | Data unit to be transmitted |
|---|---|---|
| | by AP1 to STA 11 | by STA 11 to AP 1 |
| Case 1 | Exists | Exists |
| Case 2 | Does not exist | Exists |
| Case 3 | Exists | Does not exist |
| Case 4 | Does not exist | Does not exist |

In Case 1, the AP 1 may transmit a data frame including an RDG field set to the second value (e.g., 1) to the STA 11. The STA 11 may receive the data frame from the AP 1, and may transmit a reception response frame (e.g., BA frame) to the data frame and a data frame to the AP 1. A more PPDU field included in the reception response frame transmitted by the STA 11 may be set to the second value (e.g., 1), and a value of a more PPDU field included in the data frame transmitted by the STA 11 may be set according to whether a data unit to be additionally transmitted exists in the STA 11.

In Case 2, the AP 1 may transmit a QoS Null frame (e.g., QoS Null data frame) including an RDG field set to the second value (e.g., 1) to the STA 11. The STA 11 may receive the QoS Null frame from the AP 1, and may transmit a reception response frame (e.g., BA frame) to the QoS Null frame and a data frame to the AP 1. A more PPDU field included in the reception response frame transmitted by the STA 11 may be set to the second value (e.g., 1), and a value of a more PPDU field included in the data frame transmitted by the STA 11 may be set according to whether a data unit to be additionally transmitted exists in the STA 11.

In Case 3, the AP 1 may transmit a data frame including an RDG field set to the first value (e.g., 0) or the second value (e.g., 1) to the STA 11. The STA 11 may receive the data frame from the AP 1, and may transmit a reception response frame (e.g., BA frame) to the data frame to the AP 1. A more PPDU field included in the reception response frame transmitted by the STA 11 may be set to the first value (e.g., 0). In Case 3, another communication node (e.g., AP 1 or/and STA 21) may transmit and receive a data frame in the remaining TXOP duration.

Case 4 may occur in the exemplary embodiment of FIG. 6. In this case, the AP 1 may transmit a data frame to another STA (e.g., STA 21) in the remaining TXOP duration. The data frame transmitted to the STA 21 may include a duration field and an RDG field. The duration field of the data frame may be set to a value indicating the remaining TXOP duration (e.g., t0). The RDG field of the data frame may be set to the second value (e.g., 1). The RDG field set to the second value may allow reverse direction communication to the STA 21. That is, TXOP sharing may be indicated to the STA 21. The AP 1 may be an RD initiator, and the STA 21 may be an RD responder. The STA 21 may receive the data frame from the AP 1, and may transmit a reception response frame (e.g., BA frame) to the AP 1 after a SIFS from a reception time of the data frame. When a data unit to be transmitted in the reverse direction exists in the STA 21, a more PPDU field included in the reception response frame may be set to the second value (e.g., 1). The STA 21 may generate an A-MPDU by concatenating the reception response frame and the data frame, and may transmit the A-MPDU to the AP 1. The AP 1 may receive the reception response frame and the data frame from the STA 21. The AP 1 may transmit a reception response frame to the STA 21 after a SIFS from a reception time of the data frame.

The communication node (e.g., AP 1, RD initiator) allowing reverse direction communication may limit a length of a data frame (e.g., data unit) transmitted in the reverse direction. The length of the data frame transmittable in the reverse direction may be limited to less than or equal to the length of the data frame transmitted by the RD initiator initiating the reverse direction communication. The RDG field included in the data frame transmitted by the RD initiator may be set to the second value (e.g., 1). The length of the data frame including the RDG field set to the second value (e.g., 1) may be identified based on a PPDU length indicated by an L-SIG field included in the corresponding data frame.

The RD initiator may change an AC of a data unit that the RD responder transmits in the reverse direction. For example, the RD initiator may transmit a data frame including a preferred AC field indicating an AC of a data unit transmittable in the reverse direction. The size of the preferred AC field may be 2 bits. The preferred AC field may be added to the frame when the AC constraint field is set to the first value (e.g., 0). Even when the preferred AC field indicates an AC corresponding to a TID not allocated by TID-to-link mapping, the STA may transmit a data unit having the AC indicated by the preferred AC field in the reverse direction. For example, when an AC corresponding to the TID mapped to the first link is AC_VI and the preferred AC field set by the AP 1, which is the RD initiator, indicates AC_VO, the STA 11 may transmit a data unit (e.g., PPDU) having AC_VO indicated by the preferred AC field to the AP 1 in the reverse direction.

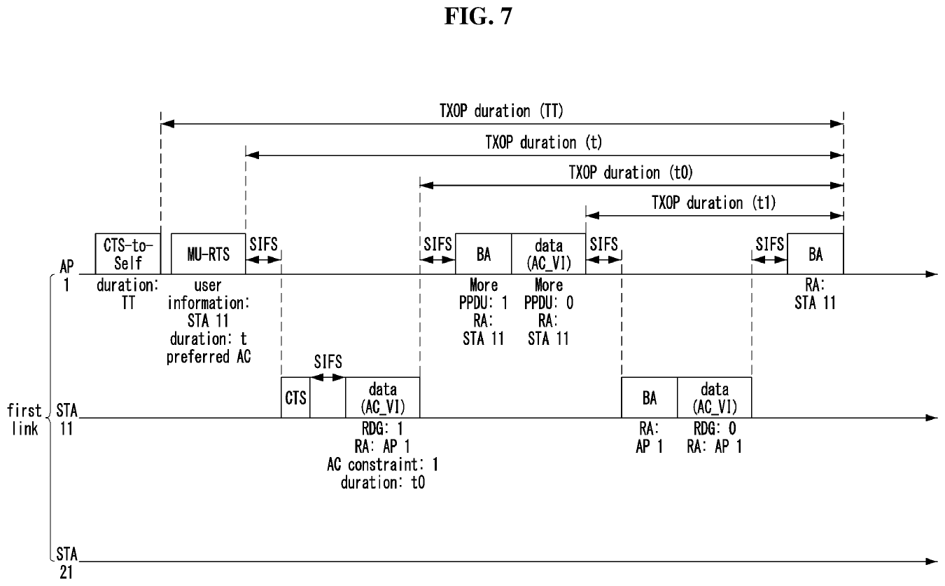

FIG. 7 is a timing diagram illustrating a second exemplary embodiment of a bidirectional communication method in a wireless LAN system.

Referring to FIG. 7, an AP MLD, a STA MLD 1, and a STA MLD 2 may support multi-link operations. An AP 1 among APs affiliated with the AP MLD may operate in a first link, a STA 11 among STAs affiliated with the STA MLD 1 may operate in the first link, and a STA 21 among STAs affiliated with the STA MLD 2 may operate in the first link.

The AP 1 may configure (or initiate, secure) a TXOP duration having a TT length by transmitting a data frame to another STA. Alternatively, the AP 1 may configure (or initiate, secure) a TXOP duration having a TT length by transmitting a clear-to-send (CTS)-to-self frame. Alternatively, the AP 1 may configure (or initiate, secure) a TXOP duration having a TT length by transmitting a trigger frame (e.g., a multi-user-request-to-send (MU-RTS) trigger frame). The above-described trigger frame may be an MU-RTS frame indicating TXOP sharing and a sharing mode to be described later. The AP 1 may share a TXOP with STA(s) within the TXOP duration having the TT length. That is, the AP 1 may allocate a TXOP to the STA 11 within the TXOP duration. The TXOP sharing mode may be classified into a TXOP sharing mode 1 and a TXOP sharing mode 2.

When the TXOP sharing mode 1 is used, communication between the communication node (e.g., AP) indicating TXOP sharing and a communication node (e.g., STA) acquiring the TXOP sharing may be performed. That is, the TXOP sharing mode 1 may indicate allowance of communication between the AP 1 and the STA 11 within a shared TXOP duration. When the TXOP sharing mode 2 is used, the communication node (e.g., STA) acquiring TXOP sharing may communicate with another communication node (e.g., another STA) within a shared TXOP duration. In the TXOP sharing mode 2, direct communication (e.g., peer-to-peer (PTP) communication) between STAs may be performed. That is, the TXOP sharing mode 2 may indicate allowance of direct communication between STAs within the TXOP duration.

The AP 1 may initiate the TXOP sharing mode 1 or the TXOP sharing mode 2 by transmitting an MU-RTS frame to a STA that is a TXOP sharing target. The MU-RTS frame may include one or more information elements. The MU-RTS frame may be used to indicate TXOP sharing. For example, the MU-RTS frame may include an information element indicating TXOP sharing. The MU-RTS frame may include an indicator indicating the TXOP sharing mode 1 or the TXOP sharing mode 2. The AP 1 may transmit an MU-RTS frame including the indicator indicating the TXOP sharing mode 1 to the STA 11. The STA 11 may receive the MU-RTS frame from the AP 1. The MU-RTS frame may be a modified trigger frame. A user information (i.e., user info) field of the MU-RTS frame may include an association identifier (AID) of the STA (e.g., STA 11) that is a TXOP sharing target. A duration field included in the MU-RTS frame may be set to a value (e.g., t) of a shared TXOP duration.

A TXOP duration having the length indicated by the duration field of the MU-RTS frame may be shared with the STA having the AID included in the user information field of the MU-RTS frame. The MU-RTS frame may further include an RDG field, and the RDG field may indicate whether reverse direction communication is allowed. When the RDG field of the MU-RTS frame is set to the second value (e.g., 1), the STA 11 may perform reverse direction communication within the TXOP duration shared by the AP 1. The MU-RTS frame may further include a preferred AC field indicating an AC of a data unit transmittable in a link to which the TXOP sharing is applied. The STA 11 may identify the preferred AC field included in the MU-RTS frame, and may transmit a data unit corresponding to the AC indicated by the preferred AC field and/or a data unit corresponding to an AC having a higher priority than the AC indicated by the preferred AC field within the shared TXOP duration.

When the STA 11 is a STA affiliated with the STA MLD 1 supporting multi-link operations, AC(s) of a data unit transmittable in the first link may be determined based on TID-to-link mapping and TID-to-AC mapping. The STA 11 may transmit a data unit corresponding to the AC indicated by the preferred AC field and/or an AC having a higher priority than the AC indicated by the preferred AC field among the AC(s) determined based on the TID-to-link mapping and the TID-to-AC mapping. Alternatively, even when the AC indicated by the preferred AC field is different from the AC determined based on the TID-to-link mapping and the TID-to-AC mapping, transmission of the data unit corresponding to the AC indicated by the preferred AC field may be allowed.

The STA 11 may receive the MU-RTS frame from the AP 1, and may transmit a CTS frame after a SIFS from a reception time of the MU-RTS frame. The STA 11 may transmit a data frame to the AP 1 after a SIFS from a transmission time of the CTS frame. ‘Acquiring TXOP sharing from the AP 1’ may mean ‘receiving allocation information of a TXOP from the AP 1’. If the TXOP is shared (e.g., allocated) to the STA 11, the STA 11 may operate as a TXOP owner or TXOP holder for the shared TXOP duration (e.g., t). When the TXOP sharing mode 1 is used, the STA 11 may perform reverse direction communication with the AP 1 during the shared TXOP duration. The STA 11 may act as an RD initiator allowing a RD communication procedure during the shared TXOP duration. The STA 11 may generate a CAS A-control field including an RDG field set to the second value (e.g., 1), and may transmit a data frame including the CAS A-control field to the AP 1.

The AP 1 may receive the data frame from the STA 11, and may transmit a reception response frame (e.g., BA frame) to the STA 11 after a SIFS from a reception time of the data frame. The AP 1 may identify that the RDG field included in the data frame is set to the second value. The AP 1 may act as an RD responder. When a data unit to be transmitted to the STA 11 exists in the AP 1, the AP 1 may generate a CAS A-control field including a more PPDU field set to the second value (e.g., 1), and may generate a reception response frame including the CAS A-control field. The AP 1 may generate an A-MPDU by concatenating the reception response frame and the data frame, and may transmit the A-MPDU to the STA 11.

Since the AP 1 operates as an RD responder, an RDG/more PPDU field included in the data frame transmitted by the AP 1 may be interpreted as a more PPDU indicator. When a data unit to be transmitted to the STA 11 does not exist in the AP 1, the AP 1 may transmit a reception response frame including a more PPDU field set to the first value (e.g., 0) to the STA 11. The STA 11 may receive the data frame from the AP 1, and may transmit a reception response frame (e.g., BA frame) to the AP 1 after a SIFS from a reception time of the data frame. When a data unit to be transmitted to the AP 1 exists in the STA 11, the STA 11 may transmit a data frame to the AP 1 together with the reception response frame. For example, the STA 11 may generate an A-MPDU by concatenating the reception response frame and the data frame, and may transmit the A-MPDU to the AP 1. The AP 1 may receive the data frame from the STA 11, and may transmit a reception response frame after a SIFS from a reception time of the data frame.

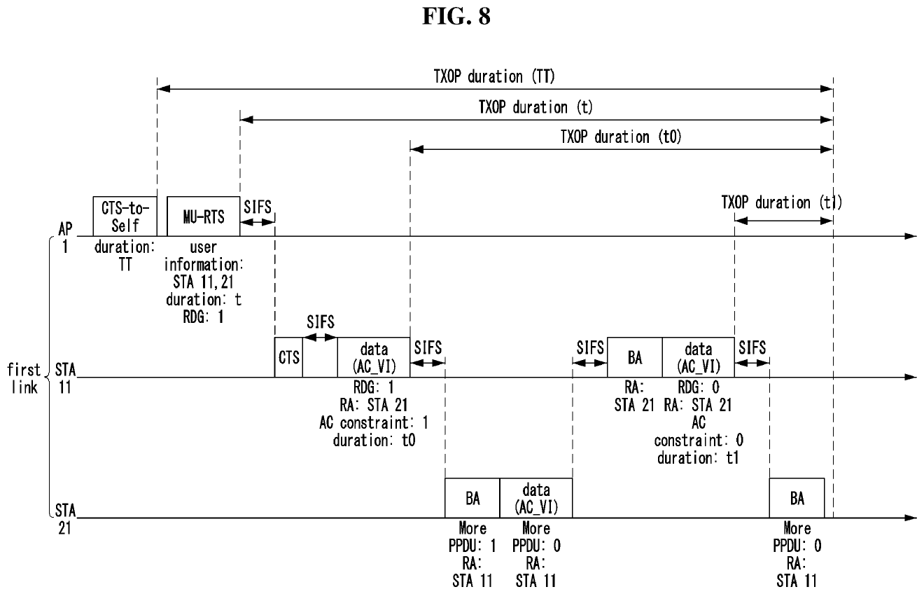

FIG. 8 is a timing diagram illustrating a third exemplary embodiment of a bidirectional communication method in a wireless LAN system.

Referring to FIG. 8, an AP MLD, a STA MLD 1, and a STA MLD 2 may support multi-link operations. An AP 1 among APs affiliated with the AP MLD may operate in a first link, a STA 11 among STAs affiliated with the STA MLD 1 may operate in the first link, and a STA 21 among STAs affiliated with the STA MLD 2 may operate in the first link.

The AP 1 may configure (or initiate, secure) a TXOP duration having a TT length by transmitting a data frame to another STA. Alternatively, the AP 1 may configure (or initiate, secure) a TXOP duration having a TT length by transmitting a CTS-to-self frame. Alternatively, the AP 1 may configure (or initiate, secure) a TXOP duration having a TT length by transmitting a trigger frame (e.g., MU-RTS trigger frame). The above-described trigger frame may be an MU-RTS frame indicating TXOP sharing and a sharing mode to be described later. The AP 1 may share a TXOP with STA(s) within the TXOP duration having the TT length. That is, the AP 1 may allocate a TXOP to the STA(s) within the TXOP duration. The TXOP sharing mode may be classified into a TXOP sharing mode 1 and a TXOP sharing mode 2. When the TXOP sharing mode 1 is used, communication between the communication node (e.g., AP) indicating TXOP sharing and a communication node (e.g., STA) acquiring the TXOP sharing may be performed. When the TXOP sharing mode 2 is used, the communication node (e.g., STA) acquiring TXOP sharing may communicate with another communication node (e.g., another STA) within a shared TXOP duration. In the TXOP sharing mode 2, direct communication (e.g., PTP communication) between STAs may be performed.

The AP 1 may initiate the TXOP sharing mode 1 or the TXOP sharing mode 2 by transmitting an MU-RTS frame to a STA that is a TXOP sharing target. The MU-RTS frame may be used to indicate TXOP sharing. For example, the MU-RTS frame may include an information element indicating TXOP sharing. The MU-RTS frame may include an indicator indicating the TXOP sharing mode 1 or the TXOP sharing mode 2. The AP 1 may transmit an MU-RTS frame including the indicator indicating the TXOP sharing mode 2 to the STA 11. The STA 11 may receive the MU-RTS frame from the AP 1. The MU-RTS frame may be a modified trigger frame. A user information field of the MU-RTS frame may include an AID of the STA (e.g., STA 11) that is a TXOP sharing target. A duration field included in the MU-RTS frame may be set to a value (e.g., t) of a shared TXOP duration. When the TXOP sharing mode 2 is used, the user information field of the MU-RTS frame may further include an AID of another STA (e.g., STA 21) that communicates with the STA (e.g., STA 11) that is the TXOP sharing target.

That is, the user information field of the MU-RTS frame may include an AID of each of a plurality of STAs performing communication within the shared TXOP duration. Among the plurality of AIDs included in the user information field of the MU-RTS frame, a first AID may be the AID of the STA (e.g., STA 11) that is the TXOP sharing target. Among the plurality of AIDs included in the user information field of the MU-RTS frame, a second AID may be an AID of another STA (e.g., STA 21) communicating with the STA (e.g., STA 11) that is the TXOP sharing target. As another example of the user information field of the MU-RTS frame, the user information field of the MU-RTS frame may include only the AID of the STA that is the TXOP sharing target.

The TXOP duration having the length indicated by the duration field of the MU-RTS frame may be shared with the STAs having the AIDs included in the user information field of the MU-RTS frame. The MU-RTS frame may further include an RDG field, and the RDG field may indicate whether reverse direction communication is allowed. When the RDG field of the MU-RTS frame is set to the second value (e.g., 1), the STA 11 may perform reverse direction communication within the TXOP duration shared by the AP 1. The MU-RTS frame may further include a preferred AC field indicating an AC of a data unit transmittable in a link to which the TXOP sharing is applied. The STA 11 may identify the preferred AC field included in the MU-RTS frame, and may transmit a data unit having the AC indicated by the preferred AC field and/or a data unit having a higher priority than the AC indicated by the preferred AC field within the shared TXOP duration.

When the STA 11 is a STA affiliated with the STA MLD 1 supporting multi-link operations, AC(s) of a data unit transmittable in the first link may be determined based on TID-to-link mapping and TID-to-AC mapping. The STA 11 may transmit a data unit corresponding to the AC indicated by the preferred AC field and/or an AC having a higher priority than the AC indicated by the preferred AC field among the AC(s) determined based on the TID-to-link mapping and the TID-to-AC mapping. Alternatively, even when the AC indicated by the preferred AC field is different from the AC determined based on the TID-to-link mapping and the TID-to-AC mapping, transmission of the data unit corresponding to the AC indicated by the preferred AC field may be allowed.

The STA 11 may receive the MU-RTS frame from the AP 1, and may transmit a CTS frame after a SIFS from a reception time of the MU-RTS frame. The STA 11 may transmit a data frame to the AP 1 after a SIFS from a transmission time of the CTS frame. The STA 21 may be a target STA configured by a tunneled direct link setup (TDLS) procedure. Direct communication between the STA 11 and the STA 21 may be performed in a TDLS link. ‘Acquiring TXOP sharing from the AP 1’ may mean ‘receiving allocation information of a TXOP from the AP 1’. If the TXOP is shared (e.g., allocated) to the STA 11, the STA 11 may operate as a TXOP owner or TXOP holder for the shared TXOP duration (e.g., t). When the TXOP sharing mode 2 is used, the STA 11 may perform reverse direction communication with the STA 21 during the shared TXOP duration. The STA 11 may operate as an RD initiator allowing an RD communication procedure during the shared TXOP duration. The STA 11 may generate a CAS A-control field including an RDG field set to the second value (e.g., 1), and may transmit a data frame including the CAS A-control field to the STA 21. The data frame may include an RDG/more PPDU field and/or an AC constraint field.

The STA 21 may receive the data frame from the STA 11, and may transmit a reception response frame (e.g., BA frame) to the STA 11 after a SIFS from a reception time of the data frame. The STA 21 may identify that the RDG field included in the data frame is set to the second value. The STA 21 may operate as an RD responder. When a data unit to be transmitted to the STA 11 exists in the STA 21, the STA 21 may generate a CAS A-control field including a more PPDU field set to the second value (e.g., 1), and may generate a reception response frame including the CAS A-control field. The STA 21 may generate an A-MPDU by concatenating the reception response frame and the data frame, and may transmit the A-MPDU to the STA 11. An AC of a data unit included in the data frame of the STA 21 may be determined based on the AC constraint field included in the data frame received from the STA 11.

Since the STA 21 operates as an RD responder, an RDG/more PPDU field included in the data frame transmitted by the STA21 may be interpreted as a more PPDU indicator. When a data unit to be transmitted to STA 11 does not exist in the STA 21, the STA 21 may transmit a reception response frame including a more PPDU field set to the first value (e.g., 0) to the STA 11. The STA 11 may receive the data frame from the STA 21, and may transmit a reception response frame (e.g., BA frame) to the STA 21 after a SIFS from a reception time of the data frame. When a data unit to be transmitted to the STA 21 exists in the STA 11, the STA 11 may transmit a data frame to the STA 21 together with the reception response frame. The STA 21 may receive the data frame from the STA 11, and may transmit a reception response frame after a SIFS from a reception time of the data frame.

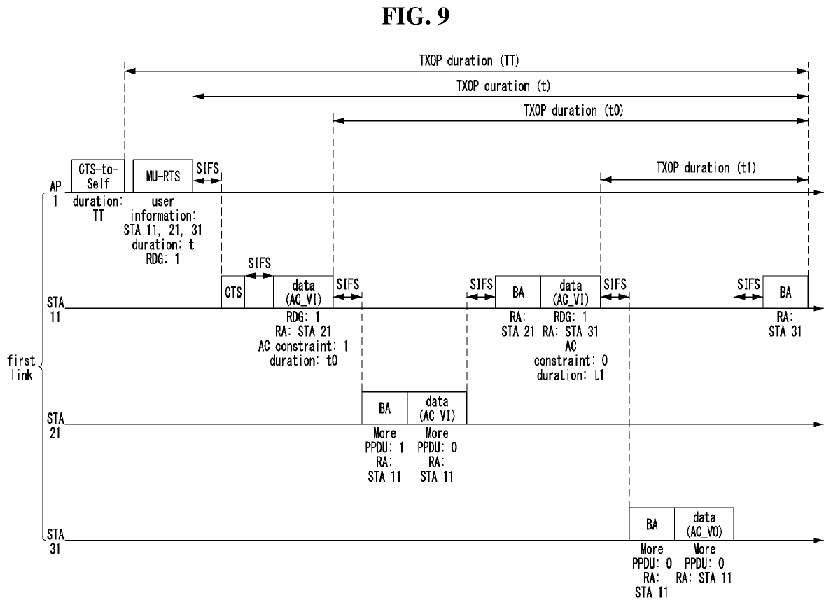

FIG. 9 is a timing diagram illustrating a fourth exemplary embodiment of a bidirectional communication method in a wireless LAN system.

Referring to FIG. 8, an AP MLD, a STA MLD 1, a STA MLD 2, and a STA MLD 3 may support multi-link operations. An AP 1 among APs affiliated with the AP MLD may operate in a first link, a STA 11 among STAs affiliated with the STA MLD 1 may operate in the first link, a STA 21 among STAs affiliated with the STA MLD 2 may operate in the first link, and a STA 31 among STAs affiliated with the STA MLD 3 may operate in the first link.

The AP 1 may configure (or initiate, secure) a TXOP duration having a TT length by transmitting a data frame to another STA. Alternatively, the AP 1 may configure (or initiate, secure) a TXOP duration having a TT length by transmitting a CTS-to-self frame. Alternatively, the AP 1 may configure (or initiate, secure) a TXOP duration having a TT length by transmitting a trigger frame (e.g., MU-RTS trigger frame). The above-described trigger frame may be an MU-RTS frame indicating TXOP sharing and a sharing mode to be described later. The AP 1 may share a TXOP with STA(s) within the TXOP duration having the TT length. That is, the AP 1 may allocate a TXOP to the STA(s) within the TXOP duration. The AP 1 may initiate the TXOP sharing mode 2 by transmitting an MU-RTS frame to the STA 11 that is a TXOP sharing target. The MU-RTS frame may include an indicator indicating the TXOP sharing mode 2. The STA 11 may receive the MU-RTS frame from the AP 1. The MU-RTS frame may be a modified trigger frame.

A user information field of the MU-RTS frame may include an AID of each of a plurality of STAs (e.g., STA 11, STA 21, STA 31) performing communication within the shared TXOP duration. A duration field included in the MU-RTS frame may be set to a value (e.g., t) of the shared TXOP duration. Among the plurality of AIDs included in the user information field of the MU-RTS frame, a first AID may be an AID of the STA (e.g., STA 11) that is the TXOP sharing target. The STA with the first AID may be a shared TXOP owner or a shared TXOP holder. Among the plurality of AIDs included in the user information field of the MU-RTS frame, the AID(s) after the first AID may be the AID(s) of the STA(s) communicating with the TXOP owner within the shared TXOP. As another example of the user information field of the MU-RTS frame, the user information field of the MU-RTS frame may include only the AID of the STA that is the TXOP sharing target. The TXOP duration having the length indicated by the duration field of the MU-RTS frame may be shared with the STAs having the AIDs included in the user information field of the MU-RTS frame.

The MU-RTS frame may further include an RDG field, and the RDG field may indicate whether reverse direction communication is allowed. When the RDG field of the MU-RTS frame is set to the second value (e.g., 1), the STA 11 may perform reverse direction communication within the TXOP duration shared by the AP 1. The MU-RTS frame may further include a preferred AC field indicating an AC of a data unit transmittable in a link to which the TXOP sharing is applied. The STA 11 may identify the preferred AC field included in the MU-RTS frame, and may transmit a data unit corresponding to the AC indicated by the preferred AC field and/or a data unit corresponding to an AC having a higher priority than the AC indicated by the preferred AC field within the shared TXOP duration.

When the STA 11 is a STA affiliated with the STA MLD 1 supporting multi-link operations, AC(s) of a data unit transmittable in the first link may be determined based on TID-to-link mapping and TID-to-AC mapping. The STA 11 may transmit a data unit corresponding to the AC indicated by the preferred AC field and/or an AC having a higher priority than the AC indicated by the preferred AC field among the AC(s) determined based on the TID-to-link mapping and the TID-to-AC mapping. Alternatively, even when the AC indicated by the preferred AC field is different from the AC determined based on the TID-to-link mapping and the TID-to-AC mapping, transmission of the data unit corresponding to the AC indicated by the preferred AC field may be allowed.

The STA 11 may receive the MU-RTS frame from the AP 1, and may transmit a CTS frame after a SIFS from a reception time of the MU-RTS frame. The STA 11 may transmit a data frame to the STA 21 after a SIFS from a transmission time of the CTS frame. The STA 21 may be a target STA configured by a TDLS procedure. When the TXOP sharing mode 2 is used, the STA 11 may perform reverse direction communication with the STA 21 during the shared TXOP duration. The STA 11 may operate as an RD initiator allowing an RD communication procedure during the shared TXOP duration.

The STA 21 may receive the data frame from the STA 11, and may transmit a reception response frame (e.g., BA frame) to the STA 11 after a SIFS from a reception time of the data frame. The STA 21 may identify that the RDG field included in the data frame is set to the second value. The STA 21 may operate as an RD responder. In this case, the STA 21 may perform a reverse direction communication procedure. The reverse direction communication procedure of the STA 21 may be performed during a time (e.g., t0) indicated by a duration field included in the data frame received from the STA 11. When a data unit to be transmitted to the STA 11 exists in the STA 21, the STA 21 may generate a CAS A-control field including a more PPDU field set to the second value (e.g., 1), and may generate a reception response frame including the CAS A-control field. The STA 21 may generate an A-MPDU by concatenating the reception response frame and the data frame, and may transmit the A-MPDU to the STA 11.

Since the STA 21 operates as an RD responder, an RDG/more PPDU field included in the data frame transmitted by the STA21 may be interpreted as a more PPDU indicator. When a data unit to be transmitted to the STA 11 does not exist in the STA 21, the STA 21 may transmit a reception response frame including a more PPDU field set to the first value (e.g., 0) to the STA 11. The STA 11 may receive the data frame from the STA 21, and may transmit a reception response frame (e.g., BA frame) to the STA 21 after a SIFS from a reception time of the data frame. When the more PPDU field included in the data frame received from the STA 21 is set to the first value, the STA 11 may determine that a data unit to be additionally transmitted does not exist in the STA 21.

When a data unit to be transmitted to the STA 21 does not exist in the STA 11, and a data unit to be transmitted to the STA 31 indicated by the user information field of the MU-RTS frame received from the AP 1 exists in the STA 11, and/or when the shared TXOP remains and a data unit to be transmitted to the STA 31 exists in the STA 11, the STA 11 may transmit a data frame to the STA 31. An RDG field included in the data frame may be set to the second value (e.g., 1), and a duration field included in the data frame may be set to indicate t1. That is, the STA 11 may allow reverse direction communication to the STA 31 for the remaining TXOP duration (e.g., t1). The STA 31 may receive the data frame from the STA 11 and may identify the information element(s) included in the data frame. The STA 31 may identify that reverse direction communication is allowed for the remaining TXOP duration (e.g., t1) based on the information element(s). When a data unit to be transmitted to the STA 11 exists in the STA 31, the STA 31 may transmit a data frame to the STA 11. In this case, the data frame of the STA 31 may be transmitted to the STA 11 together with a reception response frame to the data frame received from the STA 11.

When a data unit to be transmitted to the STA 41 exists in the STA 11 and a STA 41 is not indicated by the user information field of the MU-RTS frame received from the AP 1, the STA 11 may select the STA 41 as a STA with which direct communication is to be performed, and transmit a data frame to the STA 41.

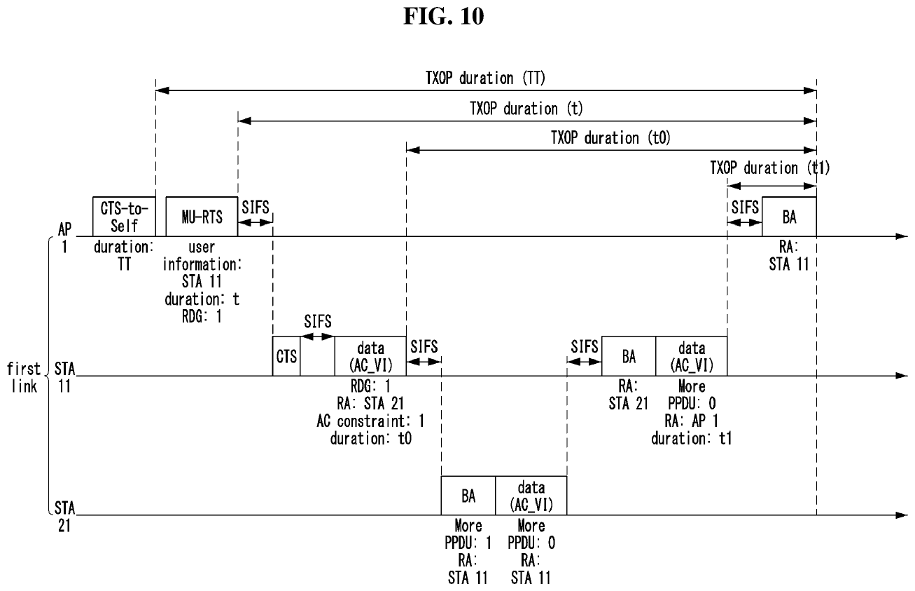

FIG. 10 is a timing diagram illustrating a fifth exemplary embodiment of a bidirectional communication method in a wireless LAN system.

Referring to FIG. 10, an AP MLD, a STA MLD 1, and a STA MLD 2 may support multi-link operations. An AP 1 among APs affiliated with the AP MLD may operate in a first link, a STA 11 among STAs affiliated with the STA MLD 1 may operate in the first link, and a STA 21 among STAs affiliated with the STA MLD 2 may operate in the first link.

The AP 1 may configure (or initiate, secure) a TXOP duration having a TT length by transmitting a data frame to another STA. Alternatively, the AP 1 may configure (or initiate, secure) a TXOP duration having a TT length by transmitting a CTS-to-self frame. Alternatively, the AP 1 may configure (or initiate, secure) a TXOP duration having a TT length by transmitting a trigger frame (e.g., MU-RTS trigger frame). The above-described trigger frame may be an MU-RTS frame indicating TXOP sharing and a sharing mode to be described later. The AP 1 may share a TXOP with STA(s) within the TXOP duration having the TT length. That is, the AP 1 may allocate a TXOP to the STA(s) within the TXOP duration.

The AP 1 may initiate the TXOP sharing mode 2 by transmitting an MU-RTS frame to a STA that is a TXOP sharing target. The MU-RTS frame may include an indicator indicating the TXOP sharing mode 2. The TXOP sharing mode 2 may mean sharing TXOP for direct communication between STAs. The AP 1 may transmit the MU-RTS frame including the indicator indicating the TXOP sharing mode 2 to the STA 11. The STA 11 may receive the MU-RTS frame from the AP 1. The MU-RTS frame may be a modified trigger frame. A user information field of the MU-RTS frame may include an AID of the STA (e.g., STA 11) that is the TXOP sharing target. A duration field included in the MU-RTS frame may be set to a value (e.g., t) of the shared TXOP duration.

The MU-RTS frame may further include an RDG field, and the RDG field may indicate whether reverse direction communication is allowed. When the RDG field of the MU-RTS frame is set to the second value (e.g., 1), the STA 11 may perform reverse direction communication within the TXOP duration shared by the AP 1 (e.g., TXOP duration shared for direct communication). The combination of the indicator indicating the TXOP sharing mode 2 and the RDG field set to the second value may be interpreted as indicating a TXOP sharing mode 3. When the TXOP sharing mode 3 is indicated, direct communication between STAs may be performed.

The STA 11 may transmit a data frame to the STA 21 during the shared TXOP duration (e.g., t). If the TXOP is shared (e.g., allocated) to the STA 11, the STA 11 may operate as a TXOP owner or TXOP holder for the shared TXOP duration (e.g., t). The STA 11 may perform reverse direction communication with the STA 21 during the shared TXOP duration. The STA 11 may operate as an RD initiator allowing an RD communication procedure during the shared TXOP duration. The STA 11 may generate a CAS A-control field including an RDG field set to the second value (e.g., 1), and may transmit a data frame including the CAS A-control field to the STA 21.

Since the RDG indicator included in the MU-RTS frame received from the AP 1 indicates that reverse direction communication is allowed to the STA 11, when a data unit to be transmitted to the AP 1 exists in the STA 11, the STA 11 may transmit a data frame to the AP 1. The AP 1 allowing the reverse direction communication may operate as an RD initiator, and the STA 11 for which reverse direction communication is indicated to be allowed may operate as an RD responder. Since the STA 11 is an RD responder, an RDG/more PPDU field included in the data frame transmitted by the STA 11 to the AP 1 may be interpreted as a more PPDU indicator. When a data unit to be additionally transmitted to the AP 1 does not exist in the STA 11, the STA 11 may set the more PPDU field included in the data frame transmitted to the AP 1 to the first value (e.g., 0).

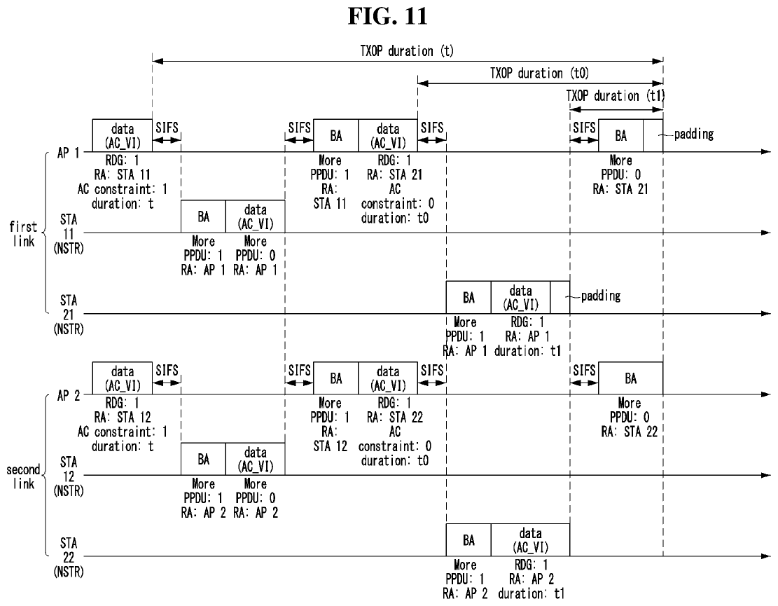

FIG. 11 is a timing diagram illustrating a sixth exemplary embodiment of a bidirectional communication method in a wireless LAN system.

Referring to FIG. 11, an AP MLD, a STA MLD 1, and a STA MLD 2 may support multi-link operations. An AP 1 among APs affiliated with the AP MLD may operate in a first link, and an AP 2 among the APs affiliated with the AP MLD may operate in a second link. A STA 11 among STAs affiliated with the STA MLD 1 may operate in the first link, and a STA 12 among the STAs affiliated with the STA MLD 1 may operate in the second link. A STA 21 among STAs affiliated with the STA MLD 2 may operate in the first link, and a STA 22 among the STAs affiliated with the STA MLD 2 may operate in the second link.

Reverse direction communication may be allowed in a multi-link. The first link and the second link may be a non-STR (NSTR) link pair in which simultaneous transmission/reception operations are impossible. Each of the STA MLD 1 and the STA MLD 2 may be an NSTR MLD that cannot perform STR communications in an NSTR link pair. When each of the STA MLD 1 and the STA MLD 2 is an NSTR MLD, for communication with each of the STA MLD 1 and the STA MLD 2 in an NSTR link pair, the AP MLD may perform synchronization communication. That is, transmission start time points and/or transmission end time points of frames in the NSTR link pair may be synchronized. Even when reverse direction communication is performed, transmission start time points and/or transmission end time points of frames in the NSTR link pair may be synchronized. When necessary, padding may be added to the frame(s) for synchronous transmission of the frames.

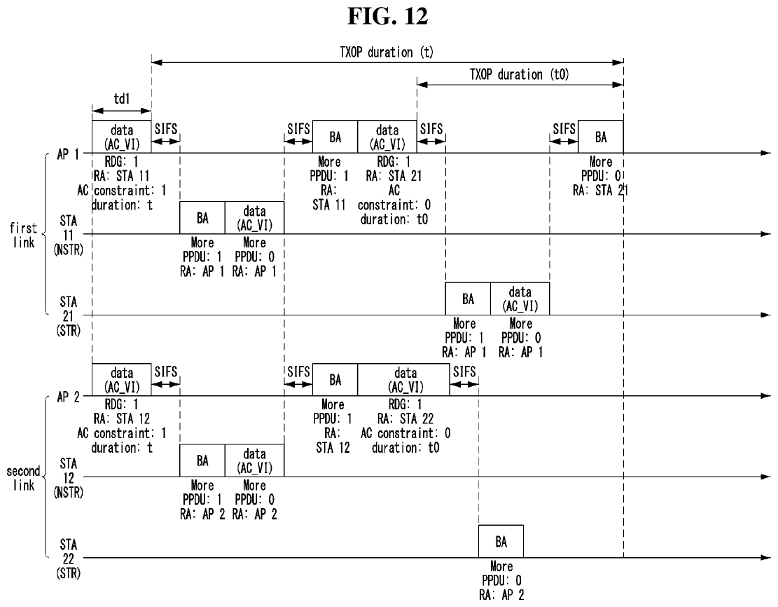

FIG. 12 is a timing diagram illustrating a seventh exemplary embodiment of a bidirectional communication method in a wireless LAN system.

Referring to FIG. 12, an AP MLD, a STA MLD 1, and a STA MLD 2 may support multi-link operations. An AP 1 among APs affiliated with the AP MLD may operate in a first link, and an AP 2 among the APs affiliated with the AP MLD may operate in a second link. A STA 11 among STAs affiliated with the STA MLD 1 may operate in the first link, and a STA 12 among the STAs affiliated with the STA MLD 1 may operate in the second link. A STA 21 among STAs affiliated with the STA MLD 2 may operate in the first link, and a STA 22 among the STAs affiliated with the STA MLD 2 may operate in the second link.

Reverse direction communication may be allowed in a multi-link. The first link and the second link may be a non-STR (NSTR) link pair in which simultaneous transmission/reception operations are impossible. The STA MLD 1 may be an NSTR MLD that cannot perform STR communications in an NSTR link pair. The STA MLD 2 may be an STR MLD that performs STR communications in an NSTR link pair. When the STA MLD 1 is an NSTR MLD, for communication with the STA MLD 1 in an NSTR link pair, the AP MLD may perform synchronization communication. That is, transmission start time points and/or transmission end time points of frames in the NSTR link pair may be synchronized. When a data unit to be transmitted to the STA MLD 1 does not exist in the AP MLD and a data unit to be transmitted to the STA MLD 2 exists in the AP MLD, the AP MLD may perform communication with the STA MLD 2. In this case, the AP MLD may transmit a frame to the STA MLD 2 independently in each link without synchronization. In reverse direction communication between the AP MLD and the STA MLD 2, synchronization may not be required.

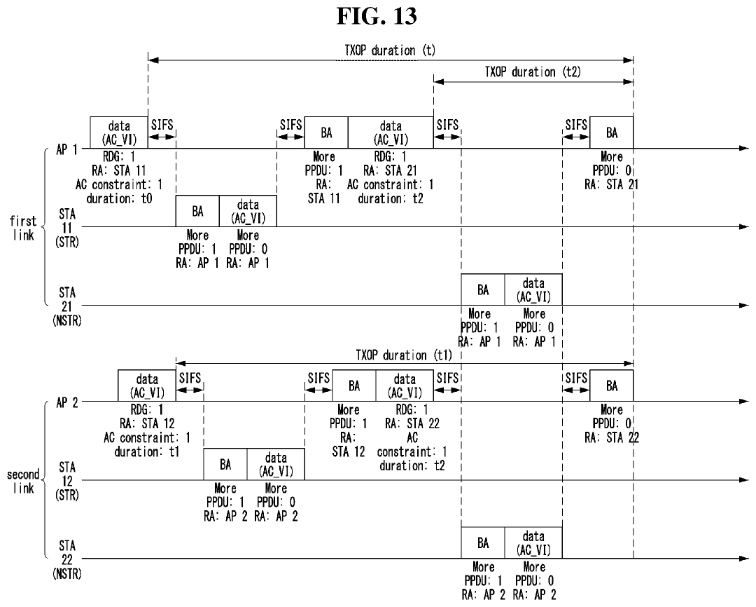

FIG. 13 is a timing diagram illustrating an eighth exemplary embodiment of a bidirectional communication method in a wireless LAN system.

Referring to FIG. 13, an AP MLD, a STA MLD 1, and a STA MLD 2 may support multi-link operations. An AP 1 among APs affiliated with the AP MLD may operate in a first link, and an AP 2 among the APs affiliated with the AP MLD may operate in a second link. A STA 11 among STAs affiliated with the STA MLD 1 may operate in the first link, and a STA 12 among the STAs affiliated with the STA MLD 1 may operate in the second link. A STA 21 among STAs affiliated with the STA MLD 2 may operate in the first link, and a STA 22 among the STAs affiliated with the STA MLD 2 may operate in the second link.

Reverse direction communication may be allowed in a multi-link. The first link and the second link may be a non-STR (NSTR) link pair in which simultaneous transmission/reception operations are impossible. The STA MLD 1 may be an STR MLD that performs STR communications in an NSTR link pair. The STA MLD 2 may be an NSTR MLD that cannot perform STR communications in an NSTR link pair. When the STA MLD 1 is an STR MLD, synchronization may not be required in communication between the AP MLD and the STA MLD 1. That is, the AP MLD may independently transmit a frame to the STA MLD 1 in each link without synchronization. In reverse direction communication between the AP MLD and the STA MLD 1, synchronization may not be required.

When a data unit to be transmitted to the STA MLD 1 does not exist in the AP MLD, and a data unit to be transmitted to the STA MLD 2 exists in the AP MLD, the AP MLD may perform synchronization communication for communication with the STA MLD 2 in an NSTR link pair. For the synchronization communication, after transmitting a reception response frame (e.g., BA frame) to the STA MLD 1, the AP MLD may adjust a length of a data frame to be transmitted to the STA MLD 2 for synchronization. In forward direction communication and/or reverse direction communication between the AP MLD and the STA MLD 2, transmission of frames may be synchronized.

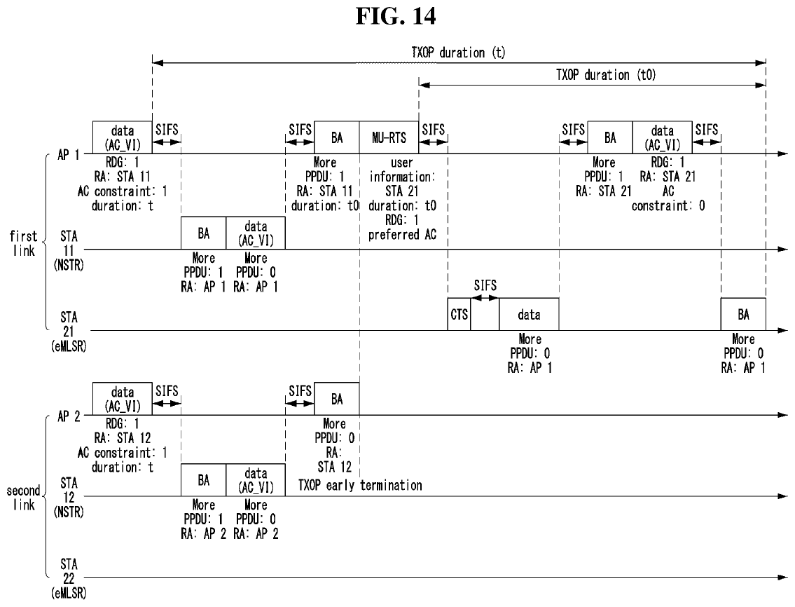

FIG. 14 is a timing diagram illustrating a ninth exemplary embodiment of a bidirectional communication method in a wireless LAN system.

Referring to FIG. 14, an AP MLD, a STA MLD 1, and a STA MLD 2 may support multi-link operations. An AP 1 among APs affiliated with the AP MLD may operate in a first link, and an AP 2 among the APs affiliated with the AP MLD may operate in a second link. A STA 11 among STAs affiliated with the STA MLD 1 may operate in the first link, and a STA 12 among the STAs affiliated with the STA MLD 1 may operate in the second link. A STA 21 among STAs affiliated with the STA MLD 2 may operate in the first link, and a STA 22 among the STAs affiliated with the STA MLD 2 may operate in the second link.

Reverse direction communication may be allowed in a multi-link. The first link and the second link may be an NSTR link pair in which simultaneous transmission/reception operations are impossible. The STA MLD 1 may be an NSTR MLD that cannot perform STR communications in an NSTR link pair. The STA MLD 2 may be an enhanced multi-link single-radio (eMLSR) device that performs communication using multiple streams in one link. When the STA MLD 1 is an NSTR MLD, the AP MLD may perform synchronization communication for communication with the STA MLD 1 in an NSTR link pair.

When a data unit to be transmitted to the STA MLD 1 does not exist in the AP MLD and a data unit to be transmitted to the STA MLD 2 exists in the AP MLD, the AP MLD may transmit a data frame to the STA MLD 2 within a TXOP duration. In this case, since the STA MLD 2 is an eMLSR device, the AP MLD may initiate a data frame transmission procedure with the STA MLD 2 by transmitting an MU-RTS frame. The MU-RTS frame may be transmitted in one link (e.g., first link) among the plurality of links. The MU-RTS frame may include a preferred AC field. The preferred AC field may indicate an AC for which reverse direction communication is allowed in the link (e.g., first link) in which the MU-RTS frame is transmitted. The preferred AC field may be interpreted as in the previous exemplary embodiments. The MU-RTS frame may include an RDG field indicating whether reverse direction communication is allowed. An RDG indicator included in the MU-RTS frame may indicate that reverse direction communication is allowed. That is, the RDG indicator included in the MU-RTS frame may be set to the second value (e.g., 1). When a data unit to be transmitted to the AP MLD exists in the STA MLD 2 (e.g., when a data unit to be transmitted in the reverse direction exists in the STA MLD 2), the STA MLD 2 may transmit a data frame to the AP MLD.

The exemplary embodiments of the present disclosure may be implemented as program instructions executable by a variety of computers and recorded on a computer-readable medium. The computer-readable medium may include a program instruction, a data file, a data structure, or a combination thereof. The program instructions recorded on the computer-readable medium may be designed and configured specifically for the present disclosure or can be publicly known and available to those who are skilled in the field of computer software.

Examples of the computer-readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

1. A method of a first station (STA), comprising:
receiving, from an access point (AP), a first frame including an information element indicating transmit opportunity (TXOP) sharing;
identifying a shared TXOP duration based on the first frame; and
performing communication with a second STA within the shared TXOP duration.

2. The method according to claim 1, further comprising transmitting a second frame which is a response to the first frame, wherein the first frame is a multi-user-request-to-send (MU-RTS) frame, and the second frame is a clear-to-send (CTS) frame.

3. The method according to claim 1, wherein:
a TXOP sharing mode is classified into a TXOP sharing mode 1 or a TXOP sharing mode 2;
the first frame further includes an information element indicating the TXOP sharing mode 2;
when the TXOP sharing mode 1 is indicated, communication between the first STA and the AP is allowed within the shared TXOP duration; and
when the TXOP sharing mode 2 is indicated, direct communication between the first STA and the second STA is allowed within the shared TXOP duration.

4. The method according to claim 1, wherein the first frame further includes an information element indicating a length of the shared TXOP duration, and the shared TXOP duration is configured within a TXOP duration initiated by the AP.

5. The method according to claim 1, wherein the first frame further includes an information element indicating whether reverse direction communication is allowed within the shared TXOP duration.

6. The method according to claim 1, wherein the first frame further includes an information element indicating an access category (AC) of a data unit transmittable in a link to which the TXOP sharing is applied.

7. The method according to claim 6, wherein the performing of the communication with the second STA comprises transmitting, to the second STA and within the shared TXOP duration, at least one of a data unit corresponding to an AC equal to the AC indicated by the first frame or a data unit corresponding to an AC having a higher priority than the AC indicated by the first frame.

8. The method according to claim 1, wherein the first frame includes an association identifier (AID) of each of a plurality of STAs performing communications within the shared TXOP duration, a first AID included in the first frame is an AID of the first STA that is a target of the TXOP sharing, and a second AID included in the first frame is an AID of the second STA.

9. The method according to claim 1, wherein the performing of the communication with the second STA comprises:
transmitting a first data frame to the second STA;
receiving a reception response frame to the first data frame from the second STA; and
receiving a second data frame from the second STA,
wherein the first data frame includes at least one of an information element indicating whether reverse direction communication is allowed within the shared TXOP duration or an information element indicating an AC of a data unit for which the reverse direction communication is allowed.

10. A method of an access point (AP), comprising:
securing a transmit opportunity (TXOP) duration;
generating a first frame including an information element indicating TXOP sharing, an information element indicating a length of a shared TXOP duration within the TXOP duration, an information element indicating that direct communication between a plurality of STAs is allowed within the shared TXOP duration, and an association identifier (AID) of each of the plurality of STAs performing the direct communication within the shared TXOP duration;
transmitting the first frame to a first STA among the plurality of STAs; and
receiving a second frame that is a response to the first frame from the first STA.

11. The method according to claim 10, wherein the TXOP duration is secured by transmitting a clear-to-send (CTS)-to-self frame, the first frame is a multi-user-request-to-send (MU-RTS) frame, and the second frame is a CTS frame.

12. The method according to claim 10, wherein the first frame further includes at least one of an information element indicating whether reverse direction communication is allowed within the shared TXOP duration or an information element indicating an access category (AC) of a data unit transmittable in a link to which the TXOP sharing is applied.

13. A first station (STA) comprising:
a processor;
a memory electronically communicating with the processor; and
instructions stored in the memory,
wherein when executed by the processor, the instructions cause the first STA to:
receive, from an access point (AP), a first frame including an information element indicating transmit opportunity (TXOP) sharing;
identify a shared TXOP duration based on the first frame; and
perform communication with a second STA within the shared TXOP duration.

14. The first STA according to claim 13, wherein:
a TXOP sharing mode is classified into a TXOP sharing mode 1 or a TXOP sharing mode 2;
the first frame further includes an information element indicating the TXOP sharing mode 2;
when the TXOP sharing mode 1 is indicated, communication between the first STA and the AP is allowed within the shared TXOP duration; and
when the TXOP sharing mode 2 is indicated, direct communication between the first STA and the second STA is allowed within the shared TXOP duration.

15. The first STA according to claim 13, wherein the first frame further includes an information element indicating a length of the shared TXOP duration, and the shared TXOP duration is configured within a TXOP duration initiated by the AP.

16. The first STA according to claim 13, wherein the first frame further includes an information element indicating whether reverse direction communication is allowed within the shared TXOP duration.

17. The first STA according to claim 13, wherein the first frame further includes an information element indicating an access category (AC) of a data unit transmittable in a link to which the TXOP sharing is applied.

18. The first STA according to claim 17, wherein in the performing of the communication with the second STA, the instructions further cause the first STA to transmit, to the second STA and within the shared TXOP duration, at least one of a data unit corresponding to an AC equal to the AC indicated by the first frame or a data unit corresponding to an AC having a higher priority than the AC indicated by the first frame.

19. The first STA according to claim 13, wherein the first frame includes an association identifier (AID) of each of a plurality of STAs performing communications within the shared TXOP duration, a first AID included in the first frame is an AID of the first STA that is a target of the TXOP sharing, and a second AID included in the first frame is an AID of the second STA.

20. The first STA according to claim 13, wherein in the performing of the communication with the second STA, the instructions further cause the first STA to:
transmit a first data frame to the second STA;
receive a reception response frame to the first data frame from the second STA; and
receive a second data frame from the second STA,
wherein the first data frame includes at least one of an information element indicating whether reverse direction communication is allowed within the shared TXOP duration or an information element indicating an AC of a data unit for which the reverse direction communication is allowed.
